(19) United States
(12) Patent Application Publication
(10) Pub. No.: US 2024/0062252 A1
(43) Pub. Date: Feb. 22, 2024

(54) COLLABORATIVE NON-FUNGIBLE TOKEN ADVERTISING SYSTEM FOR TARGETED INFLUENCE ON SOCIAL NETWORK AND METHOD THEREOF

(71) Applicant: Wildr Inc., San Francisco, CA (US)

(72) Inventors: Amit Roy Sharma, Sydney (AU); Melissa Ravi, San Francisco, CA (US); Vidit Drolia, San Francisco, CA (US)

(21) Appl. No.: 18/453,495

(22) Filed: Aug. 22, 2023

Related U.S. Application Data
(60) Provisional application No. 63/400,042, filed on Aug. 22, 2022.

(51) Int. Cl. G06Q 30/0273; G06Q 30/0241; G06Q 50/00

(52) U.S. Cl. CPC G06Q 30/0274; G06Q 30/0277; G06Q 50/01; G06Q 2220/12

(57) ABSTRACT

The Collaborative Non-Fungible Token Advertising System (100) for Targeted Influence on Social Network introduces a novel approach where brands collaborate with influencers (102) to co-create NFTs featuring brand-related contents (103). The NFTs are strategically displayed to influencer networks (104), leveraging credibility and engagement for effective advertising. Through secure blockchain technology (107) and interactive interfaces, the system (100) optimizes revenue generation (105) and revenue sharing (106), user interaction, and authenticity, thereby revolutionizing advertising dynamics within social networks.

### CROSS-REFERENCE TO RELATED APPLICATIONS

This application claims priority from U.S. provisional application Ser. No. 63/400,042 filed on 22 Aug. 2022 entitled “METHODS AND SYSTEMS OF ONLINE SOCIAL NETWORKING”, the entirety of which is herein incorporated by reference.

### DESCRIPTION OF THE INVENTION

### Technical Field of the Invention

The present invention relates to a field of digital advertising and promotion. Specifically, the invention discloses a pioneering and collaborative methodology, one that harnesses the potential of Non-Fungible Tokens (NFTs) as instrumental tools for precise and directed advertising strategies within an online social network, thereby reshaping the advertising dynamics, fostering meaningful interactions and value creation in a dynamic digital landscape.

### BACKGROUND OF THE INVENTION

In today's rapidly evolving digital landscape, traditional methods of advertising are often met with diminishing returns. Conventional advertisements, whether they be banner advertisements, pop-ups, or sponsored posts, frequently encounter advertisement fatigue as consumers become adept at tuning out such promotions.

One of the glaring gaps in current advertising strategies is the absence of a seamless integration between brands, influencers, and user interactions within the realm of online social networks. While influencer marketing has gained traction as an effective strategy, its implementation often involves third-party intermediaries and lacks a streamlined means for directly reaching and engaging with the influencer's audience.

Moreover, the potential of emerging technologies such as blockchain and non-fungible tokens (NFTs) has yet to be fully harnessed for advertising purposes. These technologies offer novel ways to establish ownership, and value in the digital realm. While NFTs have gained traction in art, and entertainment, their application in advertising remains unexplored.

Furthermore, the existing advertising ecosystem lacks a streamlined method for revenue sharing and distribution among relevant stakeholders. Influencers, who play a pivotal role in driving consumer behavior, often have limited avenues for direct financial benefit from their endorsements. This financial disconnect can lead to missed opportunities for mutually beneficial partnerships between influencers and brands.

The Patent Application No. US2022398538A1 titled “Systems Methods far Blockchain-Based Collaborative Content Generation” pertains to systems and methods of facilitating collaborative content generation within an NFT platform. One embodiment outlines a method to enhance engagement among content creators, involving receiving a request from a primary creator for secondary creators to collaborate on an initial content piece. The method identifies suitable secondary creators, sends collaboration requests, and receives acceptances. It incorporates a second content piece generated by a secondary creator, which is then tokenized for secure attribution to both primary and secondary creators. This application delves into fostering collaborative content creation within the NFT space while ensuring secure attribution of contributions.

The Patent Application No. EP3814967A1, titled “Systems and Methods for implementing Blockchain-Based Content Engagement Platforms Utilizing Media Wallets” pertains to the elucidation of systems and methodologies aimed at implementing content engagement platforms leveraging blockchain technology. These platforms encompass a registry service enabling verified content creators to generate Non-Fungible Tokens (NFTs), while media wallet applications securely store NFTs and user tokens, also capturing media consumption data. This data is aggregated within a permissioned analytics blockchain, allowing users control over data access permissions. A distinct media wallet securely stores NFTs, offers a user interface for managing data access, and records media consumption data on an immutable ledger in tandem with data access permissions. The invention establishes a comprehensive framework for secure content engagement and data management within blockchain ecosystems.

In conclusion, despite the advancements in technology and the prevalence of social media platforms, certain gaps persist within the current advertising landscape. Thus, there is a need for an innovative solution that capitalizes on the potential of NFTs, addresses the authenticity gap, and facilitates fair revenue sharing. Such solutions can significantly enhance the user experience and contribute to the evolution of a more productive and enriching online social networking landscape.

### SUMMARY OF THE INVENTION

The present invention overcomes the drawbacks of the prior art by disclosing an innovative collaborative Non-Fungible Token (NFT) advertising system and the corresponding method.

The system facilitates partnerships between companies and influencers, enabling the co-creation of NFTs that incorporate multimedia content related to brands. These NFTs serve as authentic and engaging promotional assets. Through a user-friendly interface, the system showcases NFTs directly to influencer networks, leveraging the influencer's credibility for targeted advertisement. Moreover, the invention introduces a fair revenue distribution mechanism, ensuring that influencers receive a rightful share of revenue generated from NFT transactions. Furthermore, incorporating blockchain technology, the system ensures secure NFT co-ownership and trading, enhancing the credibility and value of the advertising approach. By leveraging NFTs' uniqueness and influencers' impact, the invention revolutionizes digital advertising within social networks, fostering meaningful connections and optimizing campaign outcomes.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram disclosing a system for collaborative Non-Fungible Token (NFT) advertising for targeted influence on social network.

FIG. 2 illustrates a flow diagram disclosing a method for collaborative Non-Fungible Token (NFT) advertising for targeted influence on social network.

### DETAILED DESCRIPTION OF THE INVENTION

Reference will now be made in detail to the description of the present subject matter, one or more examples of which are shown in figures. Each example is provided to explain the subject matter. Various changes and modifications obvious to one skilled in the art to which the invention pertains, are deemed to be within the spirit, scope and contemplation of the invention.

The terminology used in the description presented herein is not intended to be interpreted in any limited or restrictive way, simply because it is being utilized in conjunction with detailed description of certain specific embodiments of the invention.

The present invention discloses a collaborative NFT advertising system (100) on social networking platform (101) featuring an interconnected ecosystem wherein brands and influencers form partnerships (Partnership Establishment Module) (102) and create co-owned NFTs (Collaborative NFT Creation Module) (103) by embodying the brand-related contents. These NFTs are strategically showcased via an interactive interface (Advertisement Display Module) (104) to the influencer's network. User engagement drives revenue generation (Revenue Generation Module) (105), with fair distribution (Revenue Distribution Module) (106) wherein Blockchain Technology (107) ensures secure co-ownership revolutionizing advertising within social networks.

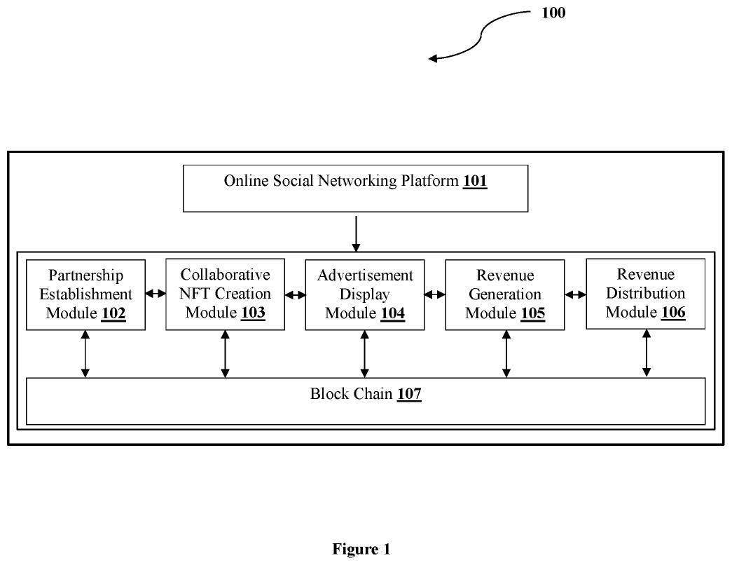

FIG. 1 illustrates a block diagram disclosing a collaborative Non-Fungible Token (NFT) advertising system (100) for targeted influence on social networking platform (101). The system (100) comprises a Partnership Establishment Module (102), a collaborative NFT Creation Module (103), an Advertisement Display Module (104), a Revenue Generation Module (105), a Revenue Distribution Module (106) along with a block chain technology (107).

In one embodiment, a company initiates a process of partnership by identifying potential influencers or content creators based on their follower demographics and content relevance to the company. In one embodiment, a company establishes partnership with a selected influencer and negotiates collaboration terms, including NFT co-ownership and revenue sharing.

Moreover, the system (100) comprises a collaborative NFT Creation Module (103) wherein the brands and influencers work together to design NFTs that incorporate multimedia content related to the brand. This module ensures the collaborative creation of compelling NFT assets.

Furthermore, the system (100) comprises Advertisement Display Module (104), accessible to the influencer's network, enabling users to view, engage with, and potentially acquire the NFTs.

In addition, the system (100) comprises a revenue generation module (105) wherein users within the influencer's network interested in the NFTs can purchase or trade them using digital currencies, leading to revenue generation from NFT transactions.

Further, the system (100) comprises a revenue distribution module (106) wherein revenue generated from NFT transactions is distributed among the influencer and the online social network platform in a fair and predetermined manner, incentivizing continued collaboration.

Blockchain Technology (107) underpins the entire system (100), ensuring secure co-ownership and trading of NFTs thereby enhancing the transparency, immutability, and security within the NFT-based advertising ecosystem.

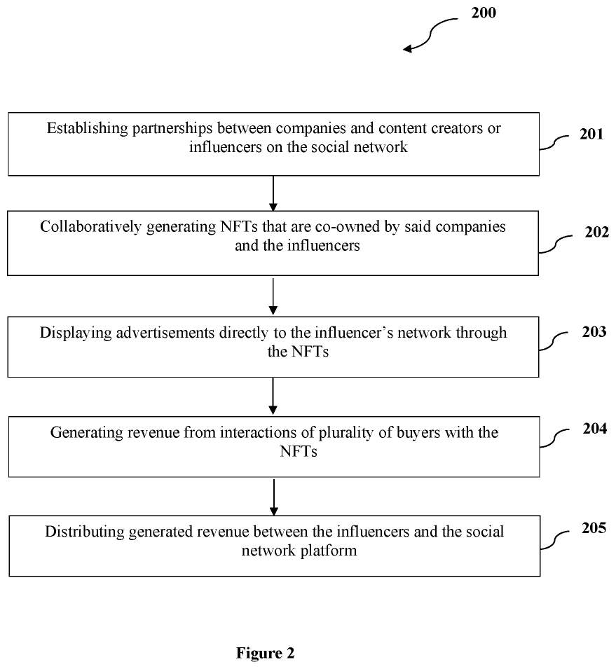

FIG. 2 illustrates a flow diagram disclosing a method for collaborative Non-Fungible Token (NFT) advertising for targeted influence on social network (200). The method (200) unfolds through a series of steps, commencing with step (201), which involves the establishment of partnerships between entities encompassing companies, content creators, or influencers, within the context of the social network. Progressing to step (202), NFTs are collaboratively generated. Moving forward, step (203) focuses on the direct showcasing of advertisements within the influencer's network, accomplished through the utilization of NFTs as a channel. This leads to a smooth transition into step (204), where the generation of revenue follows from interactions among a diverse multitude of buyers and the NFTs. Finally at step (205), the generated revenue is fairly distributed between the online platform and the influencer.

There are several advantages of the present invention including efficiently introduction of a collaborative non-fungible token advertising system within the realm of online social networks. By enabling companies to directly partner with content creators or influencers, the invention establishes a direct channel for delivering tailored and engaging advertisements to influencer networks. This approach leverages the influencers' credibility and reach to amplify the impact of advertisements, fostering a sense of authenticity and relevance that is often missing in traditional advertising methods.

Moreover, another advantage of the present invention is the partnership between brands and influencers that creates a shared interest in the success of the advertising campaign. This incentivizes both parties to craft compelling and high-quality content that resonates with the influencer's audience, ensuring that the advertisements are seamlessly integrated into the user experience.

In conclusion, the invention represents a pioneering response to the shortcomings of existing advertising practices. By harnessing the power of collaborative non-fungible token advertising within online social networks, it bridges the gap between brands, influencers, and consumers, ushering in a new era of engaging, impactful, and effective advertising strategies.

TABLE 1
Reference numbers:

| | Reference |
|---|---|
| Components | Numbers |
| System | 100 |
| Online Social Networking Platform | 101 |
| Partnership Establishment Module | 102 |
| Collaborative NFT Creation Module | 103 |
| Advertisement Display Module | 104 |
| Revenue Generation Module | 105 |
| Revenue Distribution Module | 106 |
| Blockchain Technology | 107 |

We claim:

1. A collaborative Non-Fungible Token (NFT) advertising system for a targeted influence on a social network, the system (100) comprising:
a. a partnership establishment module (102) configured to form a partnership between a company and a content creator or an influencer;
b. a collaborative NFT creation module (103) configured to generate a plurality of NFTs co-owned by the company and the influencer;
c. an advertisement display module (104) configured for showcasing an advertisement directly to the influencer's network through the NFTs;
d. a revenue generation module (105) configured to create a revenue from one or more interactions of a buyer with the NFTs; and
e. a revenue distribution module (106) configured for sharing generated revenue between said influencers and a social network platform.

2. The system (100) as claimed in claim 1, wherein the NFT created in partnership with the company and the influencer includes multimedia content comprising plurality of images, videos, audio, or a combination thereof, enhancing the engagement and appeal of the advertisement to the influencer's network.

3. The system (100) as claimed in claim 1, wherein the collaborative NFT creation module (102) utilizes blockchain technology for securing co-ownership and trading of the NFTs.

4. A method for implementing targeted influence advertising on a social network using collaborative non-fungible tokens (NFTs), the method (200) comprising the steps of:
a. establishing one or more partnerships between a company and a content creator or an influencer on the social network (201);
b. collaboratively generating plurality of NFTs that are co-owned by said companies and said influencers (202);
c. displaying an advertisement by means of an advertisement display module directly to the influencer's network through the NFTs (203);
d. generating revenue from the interactions of plurality of buyers with the NFTs (204); and
e. distributing the generated revenue between the influencers and the social network platform (205).

5. The method as claimed in claim 4, wherein the advertisements to the influencer's network through the NFT (203) allows users to engage with the advertisement content and enhancing user involvement and retention.
